(19) United States
(12) Patent Application Publication
(10) Pub. No.: US 2002/0032572 A1
(43) Pub. Date: Mar. 14, 2002

(54) Home delivery method, home-delivery server and recording medium

(76) Inventors: Takashi Ikemori, Kawasaki (JP); Akihiro Shinomura, Kawasaki (JP); Masanori Mori, Kawasaki (JP)

Correspondence Address: STAAS & HALSEY LLP, 700 11TH STREET, NW, SUITE 500, WASHINGTON, DC, 20001, US

(21) Appl. No.: 09/778,917

(22) Filed: Feb. 8, 2001

(30) Foreign Application Priority Data
Sep. 8, 2000 (JP) 2000-272587

(51) Int. Cl. G06F 17/60

(52) U.S. Cl. 705/1

(57) ABSTRACT

A home-delivery method is provided in which the efficiency of delivering parcels can be improved, and a receiver can receive a parcel at a convenient day and time in a convenient place. The method comprises steps of registering consignment information of a parcel to be received by a receiver in a home-delivery server (#14), transmitting parcel information from the home-delivery server to a terminal of the receiver after the consignment information is registered in the home-delivery server and before the parcel is delivered (#15), receiving information about a day, a time and a convenience store that the receiver designates for receiving the parcel by the home-delivery server (#16), and delivering a collected parcel to the convenience store that is designated by the receiver (#17).

### BACKGROUND OF THE INVENTION

1. Field of the Invention

The present invention relates to a home-delivery method, a home-delivery server and a recording medium for enabling a receiver to receive a parcel easily via the Internet.

2. Description of the prior art

Conventionally, a home-delivery service is widespread in which various parcels are delivered to the home of a receiver. In the home-delivery service, if the receiver is not at home when a deliveryman takes a parcel to the receiver's home, the deliveryman may deposit a note in a postbox and bring the parcel back to a delivery center temporarily. After that, the receiver who saw the note makes contact with the home-delivery company and designates convenient time to receive. Usually, the place where the receiver can receive the parcel cannot be changed from the receiver's home.

As explained above, since a parcel is delivered to the receiver's home in the conventional home-delivery service, the delivery cannot be performed smoothly if the receiver is absent. Therefore, for the home-delivery company, it is not efficient with much effort for the delivery. The receiver should manage to stay at home for receiving the parcel since the time or a day of week for receiving the parcel is subject to some constraints. Particularly, in these days, such a tendency may affect increasing workers who live single or families where both parents work.

As one solution of this problem, it is proposed to store a parcel temporarily in a storage box located in a convenience store when the receiver of the parcel was absent (see Japanese Unexamined patent publication No. 8-13916)

However, in the home-delivery method disclosed in the above-mentioned publication, a parcel is once delivered to the receiver's home and then is carried to a storage box in a convenience store after the absence of the receiver was found. Therefore, the method is still not efficient for a deliveryman who has to delivery the parcel to the receiver's home and to carry the parcel back to a convenience store.

In addition, since the receiver is informed that the parcel was stored in the storage box in the convenience store after the parcel was really stored in the storage box, it takes some time until the receiver receives the parcel actually. Particularly, if the receiver is not in the vicinity of the receiver's home due to a trip or other reason, the parcel may be stored in the storage box for a long period of time.

In this case, as explained in Japanese Unexamined patent publication No. 8-287158, the home-delivery company can inquire of the receiver about a convenient day and time for receiving the parcel. However, even if the home-delivery company does so, the deliveryman cannot deliver the parcel during the period while the receiver is not in the vicinity of the receiver's home, and the receiver cannot receive the parcel.

### SUMMARY OF THE INVENTION

An object of the present invention is to provide a home-delivery method, a home-delivery server and a recording medium in which a home-delivery company can improve an efficiency of delivering a parcel, and a receiver can receive the parcel at a convenient day and time in a convenient place.

A home-delivery method according to the present invention for a receiver to receive a parcel includes steps of, registering consignment information of the parcel to be received by the receiver in a home-delivery server, transmitting the parcel information from the home-delivery server to a receiver's terminal after the consignment information is registered in the home-delivery server and before the parcel is delivered, receiving information by the home-delivery server, the information being about a day, a time and a consignment relay station that the receiver designates for receiving the parcel, and delivering a collected parcel to the consignment relay station that is designated by the receiver.

Preferably, the parcel information includes information about contents, weight and dimensions of the parcel, and the receiver designates the consignment relay station by selecting a place for receiving a parcel from a group including at least the receiver's home and working place.

In addition, the registering step includes the steps of transmitting a map of the area selected by the receiver to the receiver's terminal from the home-delivery server, and selecting a consignment relay station such as a convenience store displayed on the receiver's terminal by the receiver.

In addition, information about a privilege is displayed, the privilege being given to the receiver when the receiver receives the parcel at the designated day and time in the displayed consignment relay station such as the convenience store. Furthermore, information about an advertisement of good dealt in the convenience store and a current campaign can be displayed.

A home-delivery server according to the present invention comprises a database for registering consignment information about the parcel to be transmitted to the receiver, means for transmitting parcel information to a receiver's terminal after the consignment information is registered in the home-delivery server and before the parcel is delivered, means for receiving information about a day, a time and a consignment relay station that the receiver designates for receiving a parcel and means for instructing the consignment relay station designated by the receiver to deliver the parcel.

Preferably, the home-delivery server further comprises means for transmitting a map including a consignment relay station in the area selected by the receiver for the receiver to designate a consignment relay station such as a convenience store.

In addition, the home-delivery server further comprises means for informing the receiver of a message at a timing before the day and time designated by the receiver, the message being for inviting the receiver to receive the parcel.

A computer-readable recording medium according to the present invention stores a program executed by a computer in a home-delivery system for a receiver to receive a parcel.

The program comprises the steps of registering consignment information in a database of a home-delivery server, transmitting parcel information to a receiver s terminal after the consignment information is registered in the database and before the parcel is delivered, receiving information about a day, a time and a consignment relay station that the receiver designates for receiving the parcel, and instructing the consignment relay station designated by the receiver to deliver the parcel.

The home-delivery server according to the present invention is administered by a home-delivery company. The home-delivery company delivers a parcel consigned by a consignor to a receiver. The receiver can receive the parcel at home or in a convenience store that the receiver designates. The convenience store temporarily stores a parcel that was delivered by the home-delivery company and delivers the parcel to the receiver after confirmation when the receiver comes to receive the parcel.

The home-delivery server is realized by utilizing a personal computer, a workstation or a general-purpose computer. The program for executing the method of the present invention is stored in a recording medium such as a semiconductor memory, a hard disk, a CD-ROM, a floppy disk or a magneto-optical disk.

### BRIEF DESCRIPTION OF THE DRAWINGS

FIG. 1 is a block diagram showing an entire structure of a home-delivery system according to an embodiment of the present invention.

FIG. 2 is a diagram showing an example of a user information database.

FIG. 3 is a diagram showing an example of a convenience store information database.

FIG. 4 is a diagram showing an example of a consignment information database.

FIG. 5 is a diagram showing a parcel information database.

FIG. 6 is a diagram showing an example of a reduction information database.

FIG. 7 is a diagram showing a function realized by the processing portion.

FIG. 8 shows a consignment information notice screen picture.

FIG. 9 shows a login screen for logging in a home page of the home-delivery server.

FIG. 10 shows a parcel list screen picture.

FIGS. 11-13 show consignment date and time designation screen pictures.

FIG. 14 shows an attention notice setting screen picture.

FIG. 15 shows an attention notice screen picture.

FIG. 16 shows a receipt screen picture.

FIG. 17 is a general flowchart of the process in the home-delivery system.

FIG. 18 shows a form of a recording medium of a program for executing a method according to the present invention.

### DESCRIPTION OF THE PREFERRED EMBODIMENTS

Hereinafter, the present invention will be explained more in detail with reference to embodiments and drawings.

In this embodiment, an example of utilizing a convenience store as a consignment relay station will be explained.

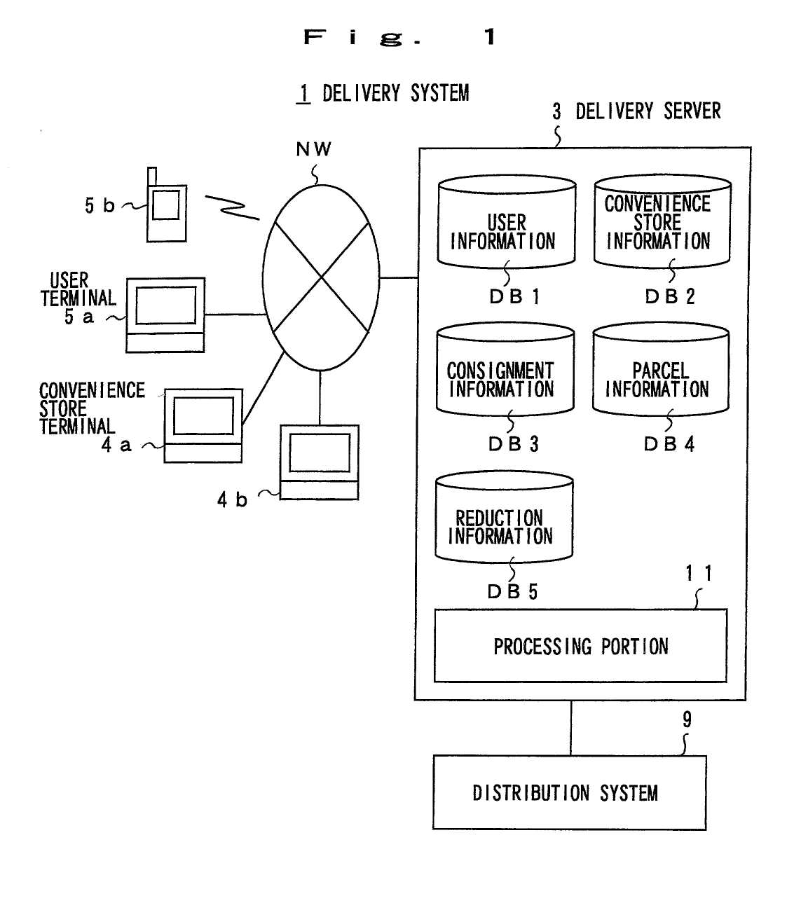

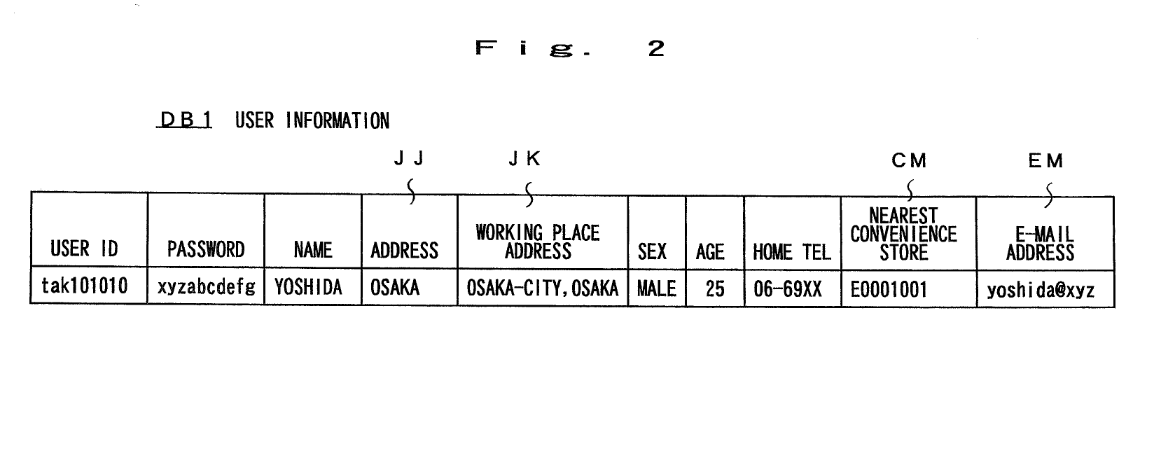

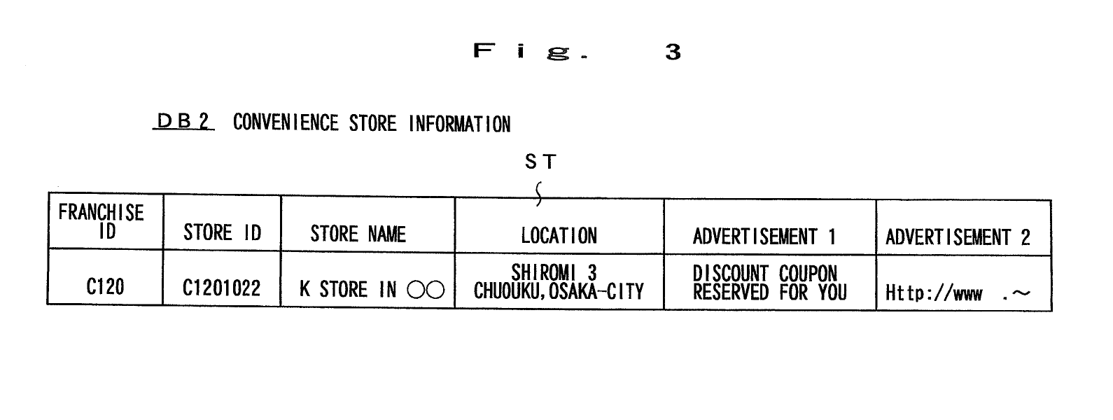

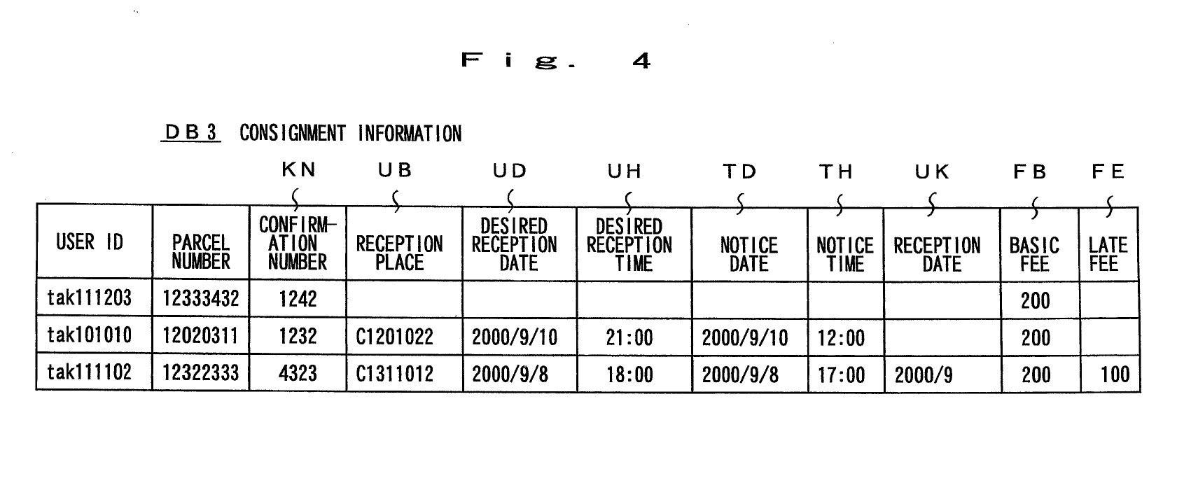

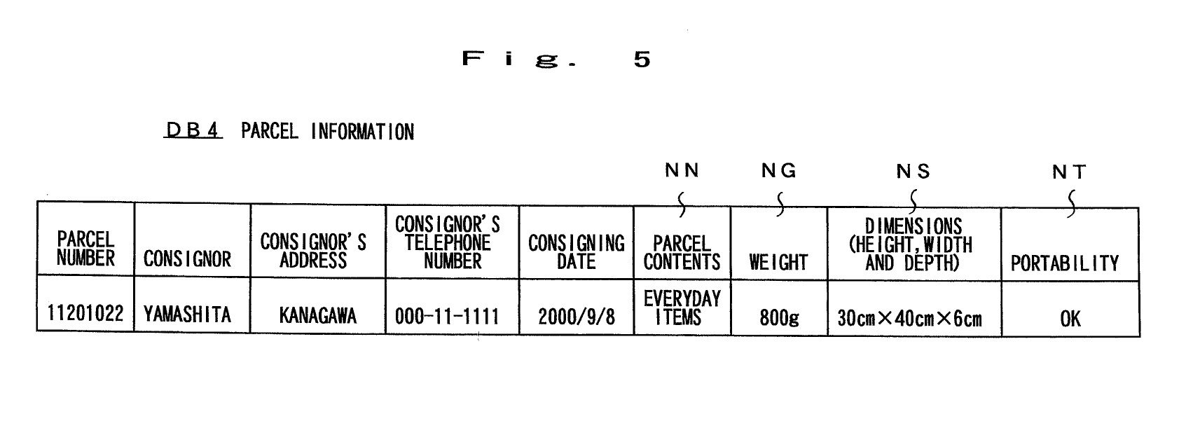

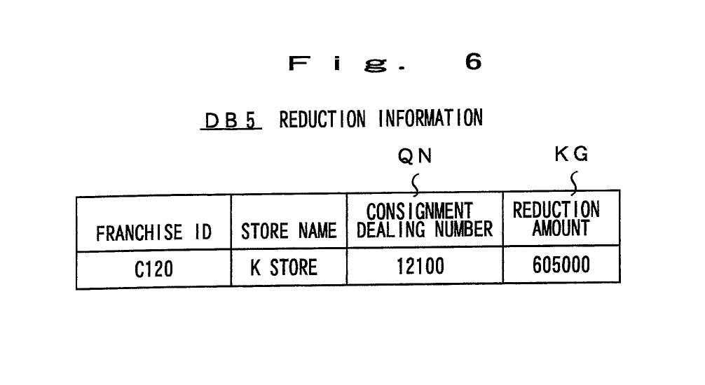

FIG. 1 is a block diagram showing an entire structure of a home-delivery system 1 according to an embodiment of the present invention. FIG. 2 is a diagram showing an example of a user information database DB1. FIG. 3 is a diagram showing an example of a convenience store information database DB2. FIG. 4 is a diagram showing an example of a consignment information database DB3. FIG. 5 is a diagram showing a parcel information database DB4. FIG. 6 is a diagram showing an example of a reduction information database DB5.

In FIG. 1, the home-delivery system 1 includes a home-delivery server 3 administered by a home-delivery company, convenience store terminals 4a and 4b installed in the convenience store, user terminals 5a and 5b operated by a user and a distribution system 9. The home-delivery server 3, the convenience store terminals 4a and 4b, and the user terminals 5a and 5b are connected to each other via a network NW.

The network NW can be the Internet, an intranet, a WAN, a LAN, or other network. In order to perform data transmission and reception utilizing the network NW, various known servers including a mail server, a WAP server, or a HTTP server and a relay station and a communication control device are used.

In this specification, a part or the entire of the convenience store terminals 4a and 4b may be referred to as a “convenience store terminal 4.” The user terminals 5a and 5b may be referred to in the same way.

In the home-delivery system 1 of this embodiment, the home-delivery company administrates the home-delivery server 3 and the distribution system 9. The home-delivery company performs the home-delivery of the consigned parcel to a receiver that is a user. The user can receive the parcel at home or at a convenience store that was designated by the receiver. The user makes an agreement with the home-delivery company about the delivery of the parcel beforehand so as to receive the above-mentioned service (a convenience store home-delivery service) and has a membership registration in the home-delivery server 3.

The home-delivery company previously makes an agreement with the convenience store about the delivery of a parcel so that the convenience store temporarily stores a parcel and delivers the parcel to a receiver. The home-delivery company does an advertisement of the convenience store by the home-delivery server 3 and the user terminal 5 and pays a commission corresponding to a dealing amount of parcels as incentives to the convenience store.

The convenience store temporarily stores a parcel that was delivered from the home-delivery company and delivers the parcel to the receiver after confirmation when the receiver comes to receive the parcel. At that time, the convenience store collects a basic fee and a late fee from the receiver.

In the home-delivery system 1 of this embodiment, the home-delivery company delivers a parcel to a convenience store and can complete the delivery regardless of presence or absence of the user so that the distribution job can be efficient. The user can receive a parcel at convenient day and time in a convenient convenience store without any limitation of time.

Next, components of the home-delivery system 1 will be explained.

The home-delivery server 3 is a server on the Internet administered by the home-delivery company as explained above. However, another administration company separated from the home-delivery company can administer the server. The home-delivery server 3 cooperates with a conventional distribution system 9 so as to exchange various information interactively.

The home-delivery server 3 includes a database DB such as a user information database DB1, a convenience store information database DB2, a consignment information database DB3, a parcel information database DB4, or a reduction information database DB5, and a processing portion 11 for executing various processes.

The home-delivery server 3 is realized utilizing a personal computer, a workstation, or a general-purpose computer. Each function of the processing portion 11 is realized by a CPU executing a program stored in a ROM, a RAM or a magnetic disk drive, for example.

In FIG. 2, the user information database DB1 includes items such as a user ID, a password, a name, an address JJ, a working place address JK, a nearest convenience store CM, and an E-mail address EM.

In the user information database DB1, the address JJ is the home address. In accordance with the home address JJ or the working place address JK, according to the selection by the user that is a receiver, the map indicating the region including the address is displayed on the screen of the user terminal 5.

The nearest convenience store CM is a default in the case where the user receives a parcel in the convenience store. Namely, if the user designated to receive a parcel in a convenience store and didn't designate the convenience store where a parcel is received, the convenience store that is registered as the nearest convenience store CM is the place where the user receives a parcel.

The E-mail address EM is information indicating an address of the electronic mail that is used when the home-delivery server 3 informs the user that there is a parcel to be received by the user and of the parcel information indicating the contents of the parcel. In addition, the E-mail address EM is used for sending other messages and data. The information can be given to the user using a telephone or a facsimile. In this case, a telephone number or a facsimile number is registered.

Each item of the user information database DB1 is registered when the user applies to the home-delivery company for an agreement about the delivery of a parcel. For example, the user accesses the home-delivery server 3 via the home page of the home-delivery company using the user terminal 5 or directly accesses the home-delivery server 3 for inputting necessary matters. Otherwise, the user fills in a sheet of form about necessary matters and sends the sheet to the home-delivery company. Then, the home-delivery company who receives the sheet input the data. The user ID is assigned to each user upon the registration, and the user is informed of the user ID. The home-delivery company may issue a membership card to each user.

The user information database DB1 can cooperate with a customer database that is provided to the distribution system 9, so that the various information about the user can be transferred from the customer database.

The information of the user who is registered in the user information database DB1 is transmitted to the distribution system 9 and is recorded in the customer database of the distribution system 9. Concerning the user who is recorded in the distribution system 9, when the consignment information in which the user is a receiver is registered in the distribution system 9, the consignment information is automatically transmitted from the distribution system 9 to the home-delivery server 3.

In the home-delivery server 3, the consignment information transmitted from the distribution system 9 is registered in the consignment information database DB3 and the parcel information database DB4. Necessary information among the registered consignment information is transmitted to the user terminal 5 as parcel information.

In the distribution system 9, the consignment information is registered in the distribution system 9 when parcels are collected, and the consignment information about the corresponding user is transmitted to the home-delivery server 3. In FIG. 3, the convenience store information database DB2 includes items such as a franchise ID, a convenience store ID, a store name, a location ST, an advertisement 1, and an advertisement 2.

The franchise ID is information for identifying a franchise chain of the convenience store, while the convenience store ID is information for identifying each convenience store that belongs to the franchise chain. Corresponding to the convenience store ID, the store name and the location ST are uniquely set, so that the convenience store ID can identify the position.

The advertisement 1 and the advertisement 2 are information for advertising the convenience store. For example, privileges are shown that are provided when using the convenience store, especially, when the user designates the convenience store for receiving a parcel, or when the user receives the parcel in the designated period (usually a day).

Items of the convenience store information database DB2 are registered after the administration company and the convenience store make the agreement about the delivery of a parcel.

In FIG. 4, the consignment information database DB3 includes items such as a user ID, a parcel number, a confirmation number KN, a reception place UB, a desired reception date UD, a desired reception time UH, a notice date TD, a notice time TH, a reception date UK, a basic fee FB, and a late fee FE.

The user ID corresponds to a user ID of the user information database DB1, and the user information (individual information) of the user ID can be obtained by referring the user information database DB1.

The parcel number is given to each parcel. The confirmation number KN is used for confirming that the user is the receiver of the parcel. By using the confirmation number KN, the confirmation of a receiver can be simplified.

The reception place UB is a place that the user designated for receiving a parcel. A convenience store is usually designated, and the convenience store ID thereof is recorded. The desired reception date UD is a date that the user designated, while the desired reception time UH is a time that the user designated.

The notice date TD and the notice time TH are the date and time for sending the user a message inviting the user to receive the parcel at a timing before the desired reception date UD and the desired reception time UH.

The reception date UK is a date when the receiver received the parcel actually. If a date is recorded as the reception date UK, it signifies that the parcel has been delivered to the receiver. On the contrary, if there is no record in the reception date UK, it signifies that the deliver of the parcel to the receiver is not completed.

The basic fee FB is a basic fee when a convenience store is used as a place for receiving a parcel. The late fee FE is an additional fee that is necessary when the receiver received the parcel later than the date and time that the receiver designated.

In FIG. 5, the parcel information database DB4 includes items such as a parcel number, a consignor, a consignor's address, a consignor's telephone number, a consigning date, parcel contents NN, a weight NG, dimensions NS, and a portability NT.

The parcel number corresponds to the parcel number of the consignment information database DB3. The consignor is a name of a person who consigned the parcel. The parcel content NN is a name of content of a parcel. The weight NG and the dimensions NS are weight and dimensions of a parcel. The portability NT indicates whether a person can normally carry the parcel to home. From these items the user can identify the shape, the form and the portability of the parcel. Thus, the user can decide whether to receive the parcel in the convenience store, and how to carry the parcel to home after receiving.

In FIG. 6, the reduction information database DB5 includes items such as a franchise ID, a convenience store name, a consignment dealing number QN, and a reduction amount KG.

The franchise ID corresponds to the franchise ID of the consignment information database DB3. The convenience store name corresponds to the franchise ID. The consignment dealing number QN is the number of dealing consignments corresponding to each franchise ID, i.e., a sum of dealing times of consignments in a convenience store ID that belongs to the franchise of each franchise ID. The reduction amount KG is an amount that is reduced (paid back) to the convenience store in accordance with the consignment dealing number QN.

Next, a function of the processing portion 11 will be explained.

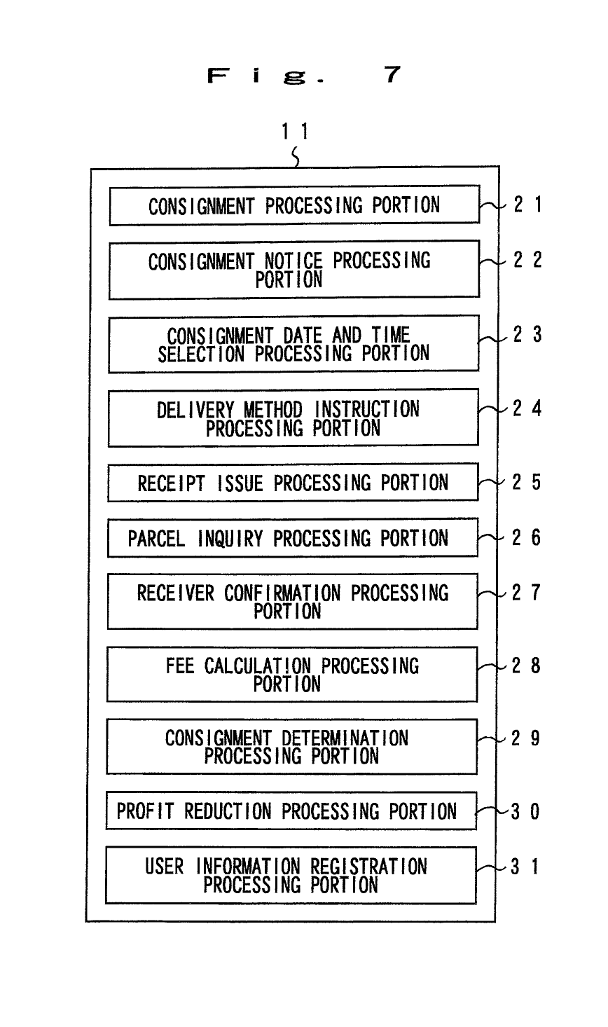

FIG. 7 is a diagram showing a function realized by the processing portion 11.

As shown in FIG. 7, the processing portion 11 realizes a consignment processing portion 21, a consignment notice processing portion 22, a consignment date and time selection processing portion 23, a delivery method instruction processing portion 24, a receipt issue processing portion 25, a parcel inquiry processing portion 26, a receiver confirmation processing portion 27, a fee calculation processing portion 28, a consignment determination processing portion 29, a profit reduction processing portion 30, and a user information registration processing portion 31.

The consignment processing portion 21 receives the consignment information from the distribution system 9 when the distribution system 9 collects the parcel and writes necessary information into the consignment information database DB3 and the parcel information database DB4.

The consignment notice processing portion 22 refers to the user information database DB1 and the parcel information database DB4, so as to inform the user of the parcel information by the method of informing the user who is previously registered. For example, an electronic mail is transmitted to the address that is recorded in the E-mail address EM.

The consignment date and time selection processing portion 23 refers to the user information database DB1 and the convenience store information database DB2, and transmits a screen picture in which the user designates the date, the time and the place (a convenience store) for receiving the parcel to the user terminal 5. In addition, necessary data are written in the consignment information database DB3 in accordance with data that was inputted in the screen and was transmitted from the user terminal 5.

When the user designates a convenience store, it is possible to select either the user's home, a working place or other area. For example, if the user has a plan to make a business trip, the user can designate a convenience store in the destination area of the trip as the place for receiving a parcel. The selection of the place can be determined after seeing the content and shape of the parcel.

When the user designates the area, the consignment date and time selection processing portion 23 transmits a map including convenience stores in the designated area for the user to designate a convenience store. However, if the user terminal 5 is a cellular phone, the display of the map may be difficult. In this case, the user can designate the nearest convenience store in accordance with the position.

However, if the user did not designate a place for receiving a parcel, the convenience store recorded in the nearest convenience store CM is designated as explained above.

When a place for receiving a parcel is designated, the home-delivery server 3 transmits the information to the distribution system 9. The distribution system 9 determines the shortest delivery available date and time when the parcel can be delivered to the place and transmits the date and time to the home-delivery server 3. The home-delivery server 3 displays the received shortest delivery available date and time on the user terminal 5. The user designates a date and time after the date and time as the desired reception date UD and the desired reception time UH.

The delivery method instruction processing portion 24 informs the distribution system 9 of the desired reception date UD, the desired reception time UH and the reception place when they are determined. The distribution system 9 displays the informed contents on the screen, or prints the same in a bill, so as to instruct a deliveryman to deliver the parcel at the date, the time and the place.

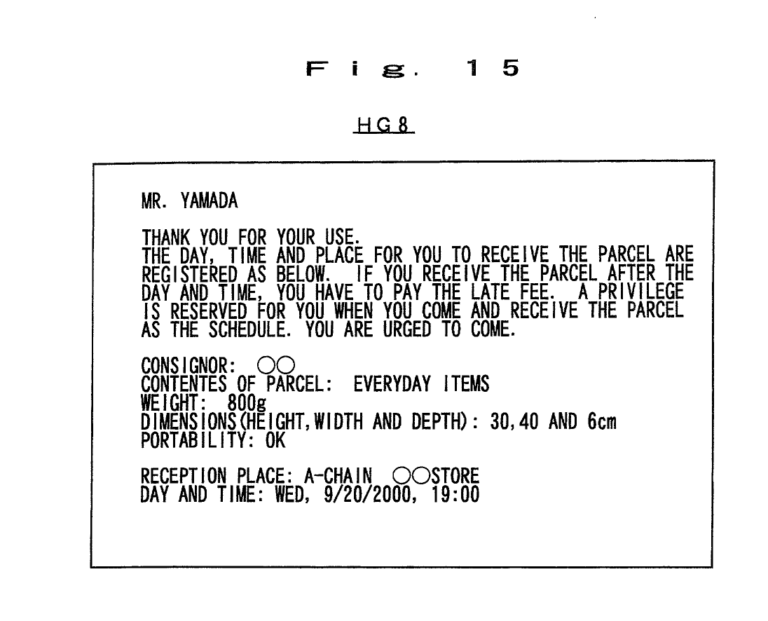

The receipt issue processing portion 25 transmits a receipt screen picture (see FIG. 15) to the user terminal 5. If the user terminal 5 has a printer, the received receipt screen picture is printed on a sheet of paper so as to make a receipt. The user brings the printed receipt to the convenience store and hands the same to a contact person for receiving the parcel.

The contact person verifies the contents of the handed receipt and the user ID, the name, the parcel number and other items displayed on the convenience store terminal 4, so as to confirm the receiver. Otherwise, the contents of the receipt are inputted from the convenience store terminal 4 and are transmitted to the home-delivery server 3, if necessary, so that the contents of the receipt are verified by the home-delivery server 3. Thus, a correct receiver is certified.

The parcel number and other items displayed on the convenience store terminal 4 are transmitted from the home-delivery server 3 to the convenience store terminal 4 by a process of the parcel inquiry processing portion 26. The parcel inquiry processing portion 26 refers to the consignment information database DB3 and the parcel information database DB4 for the process. Furthermore, the receiver confirmation processing portion 27 refers to the user information database DB1 and the consignment information database DB3, so as to check the contents of the receipt transmitted from the convenience store terminal 4.

The contact person of the convenience store receives the receipt for the parcel from the receiver and keeps the receipt as a proof of delivering the parcel.

If the user terminal 5 is a cellular phone that has no printer, the receiver may bring the user terminal 5 and may show the receipt screen picture thereon to a contact person of the convenience store for confirmation of receiving the parcel. Namely, the receipt screen picture on the user terminal 5 can be used as a receipt.

Otherwise, the convenience store terminal 4 installed in the convenience store can be used for printing the receipt. In this case, the data stored in the user terminal 5 is transmitted to the convenience store terminal 4, or data transmitted from the home-delivery server 3 to the convenience store terminal 4 are used. If the convenience store terminal 4 is a so-called kiosk terminal, a touch panel is used for inputting operation. Therefore, the operation is easy, and the user can operate the kiosk terminal. For example, the user operates the kiosk terminal and shows the outputted receipt at a cashier so as to receive a parcel. In this case, the convenience store can save the labor of delivery.

The fee calculation processing portion 28 calculates a fee for using the convenience store for delivering the parcel. The result of the calculation is displayed on the screen of the convenience store terminal 4. The fee is a sum of the basic fee FB and the late fee FE. The late fee FE is added for days of delay.

The consignment determination processing portion 29 records the date as the reception date UK of the consignment information database DB3 when the parcel is delivered to the receiver, and the fee is received from the receiver of the parcel and if necessary, the reception of the receipt is confirmed. Thus, the completion of the delivery of the parcel is recorded. In addition, the value of the consignment dealing number QN of the reduction information database DB5 is incremented.

The profit reduction processing portion 30 calculates a fee that is reduced in accordance with the dealing amount of parcels to the convenience store. The calculation is executed at a preset timing such as weekly, monthly or annually. For the calculation, a predetermined operation is executed in accordance with the consignment dealing number QN of the reduction information database DB5. The calculation result is recorded as the reduction amount KG.

In the example of the reduction information database DB5 shown in FIG. 6, the reduction amount KG is calculated for each convenience store. However, it is possible to calculate the reduction amount KG for each convenience store.

Each user can access the home-delivery server 3 or another home page of the home-delivery company, so as to register user information of a user or a method for informing a user of a parcel in the user information database DB1 previously. For this process, the user information registration processing portion 31 is provided.

Next, referring to various screen pictures displayed on the screen of the user terminal 5, a flow of a parcel in the home-delivery system 1 and a procedure of receiving a parcel will be explained.

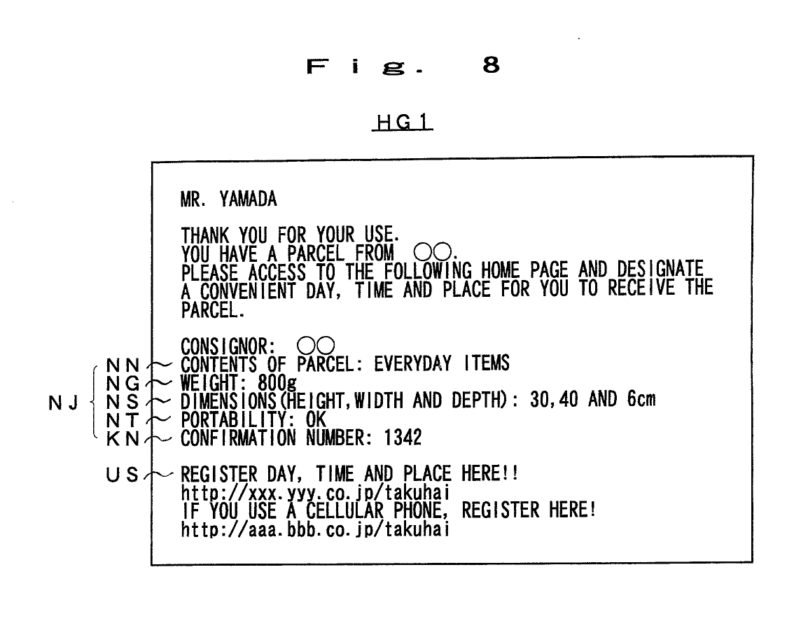

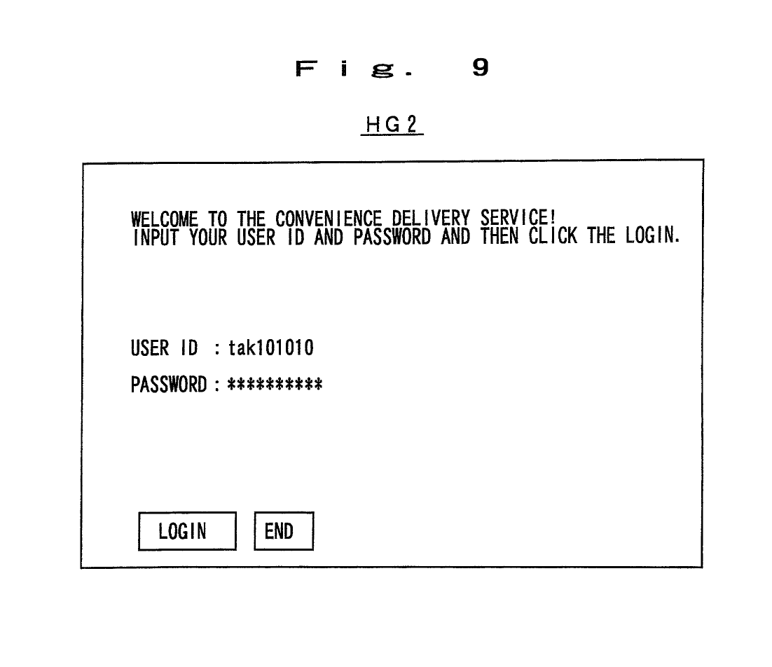

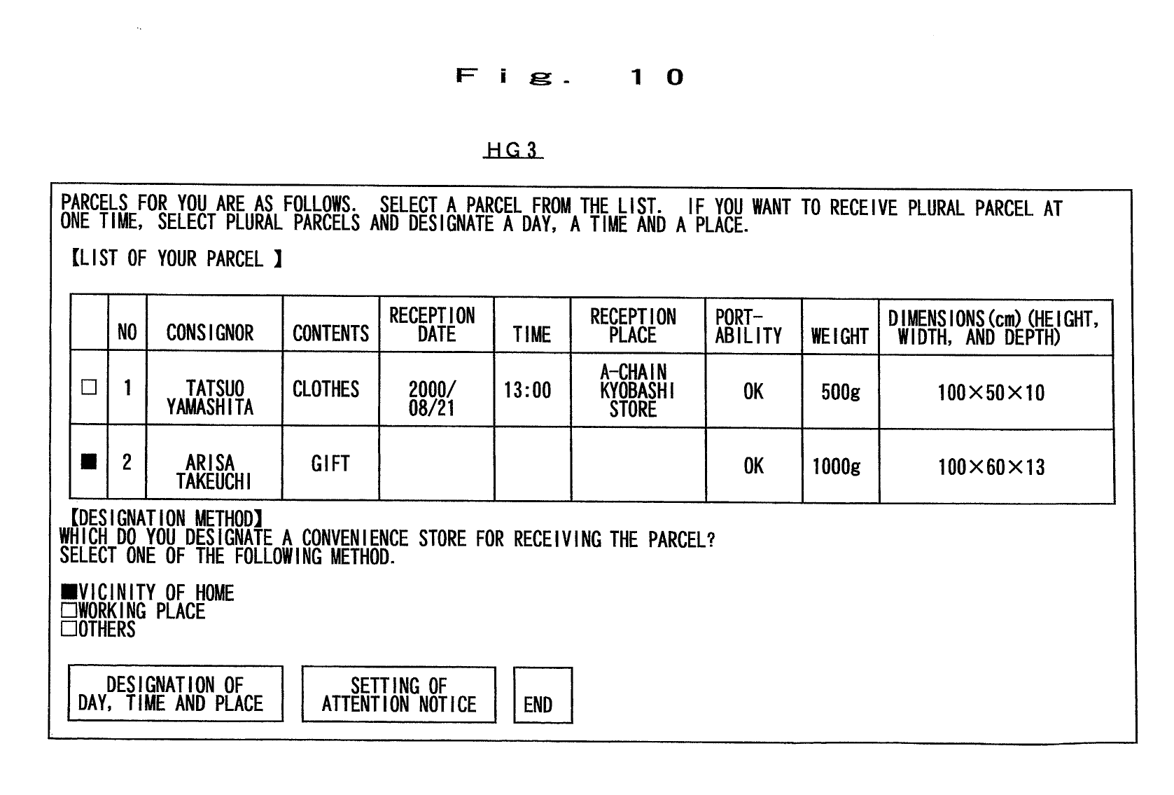

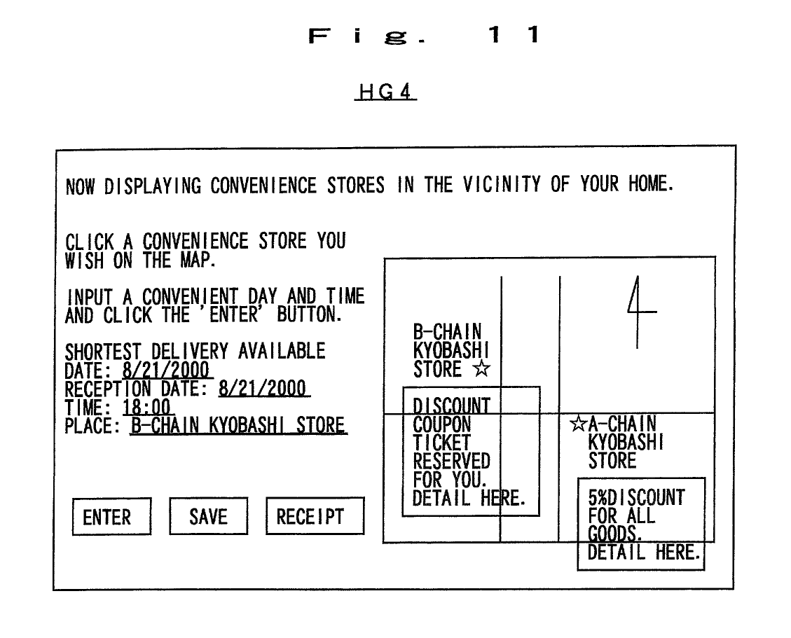

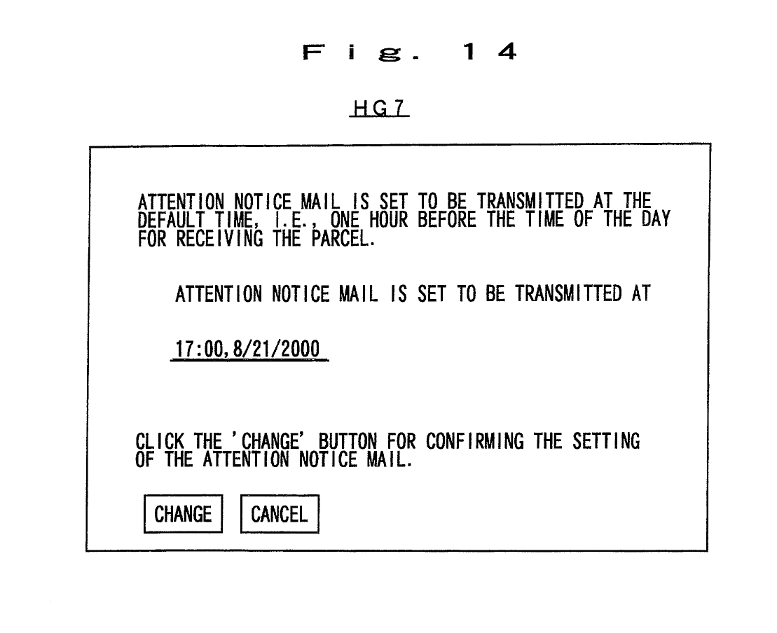

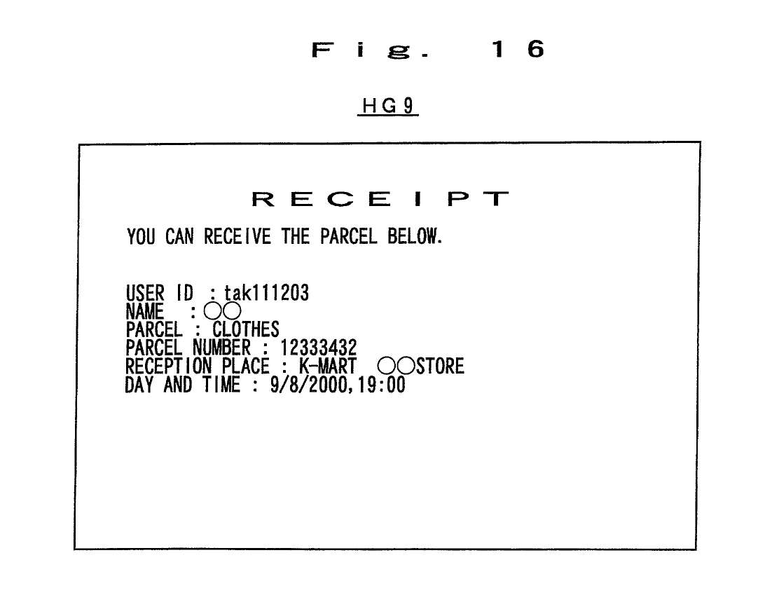

FIG. 8 shows a consignment information notice screen picture HG1. FIG. 9 shows a login screen HG2 for logging in a home page of the home-delivery server 3. FIG. 10 shows a parcel list screen picture HG3. FIGS. 11-13 show consignment date and time designation screen pictures HG4-HG6. FIG. 14 shows an attention notice setting screen picture HG7. FIG. 15 shows an attention notice screen picture HG8. FIG. 16 shows a receipt screen picture HG9.

As explained above, when the consignment information is registered in the distribution system 9, the information is transmitted to the home-delivery server 3 and is registered in the consignment information database DB3. After that, the consignment notice processing portion 22 transmits the consignment information notice to the user terminal 5. The user terminal 5 displays the notice screen picture HG1 as shown in FIG. 8.

In FIG. 8, the notice screen picture HG1 includes a parcel contents NN, a weight NG, dimensions NS, a portability NT and a confirmation number KN, which are parcel information NJ. In accordance with the parcel information NJ, a user can have a general idea about a parcel so as to know how to bring back the parcel.

Furthermore, in order to guide a user to entry a place, a day and a time for receiving a parcel, a reception setting link US is displayed that is a URL of the home page for the guidance. When the user clicks the reception setting link US, the linked home page appears, and the login screen HG2 is displayed as shown in FIG. 9.

In FIG. 9, the user inputs a user ID and a password to log in the home page. After logging in, the parcel list screen HG3 for the user is displayed.

In the parcel list screen HG3 shown in FIG. 10, the user can have a general idea about the parcel and know the reception place, day and time that are already designated. In addition, the user can select a convenience store for receiving a parcel from options of the vicinity of the home, the working place, and other places. If the user selects the “vicinity of the home,” the consignment day and time designation screen picture HG4 is displayed as shown in FIG. 11.

In FIG. 11, a map around the home is displayed, on which a position of a convenience store, a store name, a privilege and other advertisements are displayed in accordance with the convenience store information database DB2.

When a convenience store on the map is clicked, the store name of the convenience store is automatically inputted and is displayed on the screen. Corresponding to the designated convenience store, the shortest delivery available date is displayed. Then, the user inputs a desired day and time for receiving a parcel.

The user, when determining a convenience store where to receive a parcel, considers time for arriving the convenience store, the user' taste, schedule before and after receiving a parcel, a privilege obtained by designating the convenience store.

In addition, not only the privilege information about receiving a parcel but also information about an advertisement of goods dealt in the convenience store and a current campaign are displayed on the map, so that the user can select a convenience store for receiving a parcel by considering the information. Thus, it is expected for the convenience store that receivers buy goods when receiving a parcel so as to collect customers and to increase sales.

In the example of the screen picture HG4 shown in FIG. 11, if the user designates the B-chain Kyobashi store as the reception place, the user can get a discount coupon ticket when going to receive a parcel. When clicking the advertisement on the screen picture HG4, the detail information is displayed.

Thus, the user can select a convenience store on a map in which various information is displayed. Therefore, the user can make a total plan including a shopping and a visiting when making a plan of going to receive the parcel.

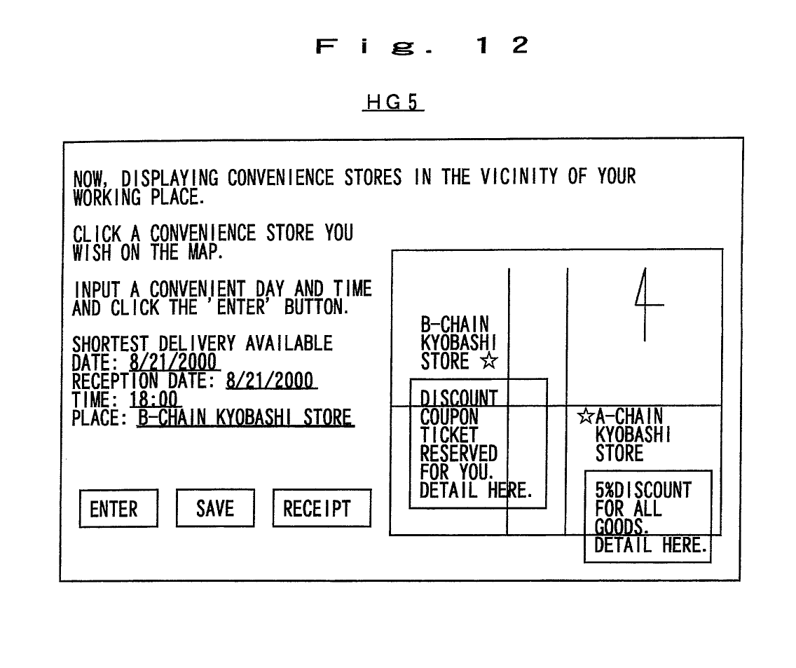

If the user selects the “working place” in the parcel list screen HG3 as shown in FIG. 10, the consignment day and time designation screen HG5 is displayed as shown in FIG. 12.

In FIG. 12, a map of the vicinity of the working place is displayed, and in the same way as FIG. 11, the position of a convenience store, a store name, privilege and other advertisements are displayed.

The user can designate a convenience store adjacent to the working place as the place for receiving the parcel, so as to drop by the place during lunchtime or on the way home. In addition, the user can select the home or the working place in accordance with the contents of the parcel.

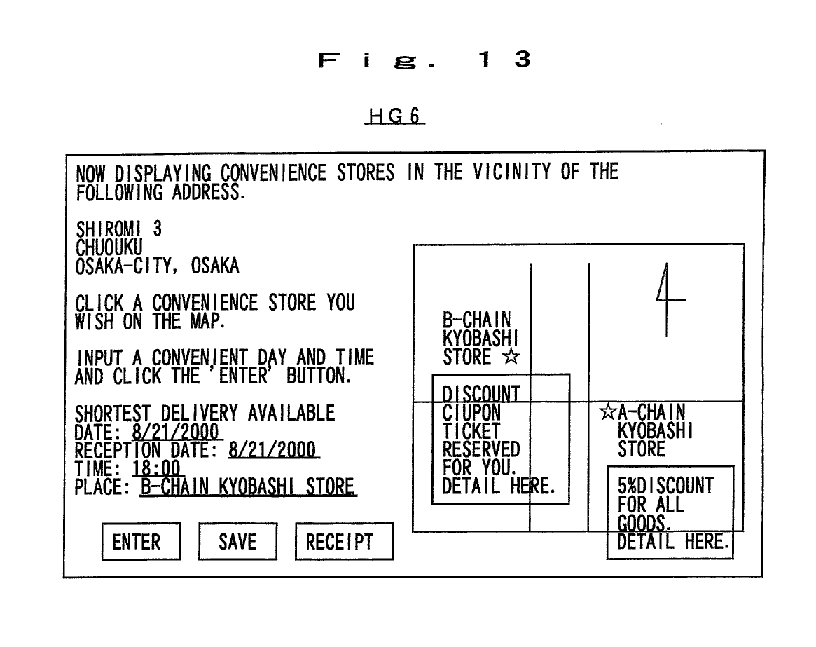

If the “others” is selected in the parcel list screen HG3 shown in FIG. 10, the consignment day and time designation screen HG6 is displayed as shown in FIG. 13.

In FIG. 13, the user inputs the reception place. This input can be selected from a pull-down menu. When inputting a place, the map of the area is displayed, and in the same as explained above, a position of a convenience store, a store name, a privilege and other advertisements are displayed.

Thus, the user can designate a convenience store in any area as a place for receiving a parcel so as to receive a parcel in a convenience place such as a trip destination or a hometown in accordance with the plan.

After finishing the designation of the place and the day and time for consignment, the attention notice setting screen picture HG7 is displayed as shown in FIG. 14.

In FIG. 14, the time of transmitting the attention notice (a reception invitation mail) is set an hour before the desired reception time that was designated as a default value. The user can change the day and time by clicking the change button.

The attention notice screen picture HG8 as shown in FIG. 15 is transmitted at the set day and time and displayed in the screen of the user terminal 5.

In FIG. 15, if the user comes to receive the parcel before the designated day and time, a privilege to be given to the user is displayed. In addition, the contents of the parcel, the reception place, day and time are displayed for confirmation.

Thus, since the attention notice is transmitted to the user terminal 5 at the set day and time, the user is reminded to receive the parcel so that the certainty for receiving the parcel is enhanced. Therefore, the convenience store can avoid the backlog of the parcel in the convenience store that is increased if the user did not come to receive, and can have an advantage in ensuring a storage place of parcels and avoiding an accident of losing a parcel.

In addition, the user terminal 5 displays a receipt screen picture HG8 as shown in FIG. 15.

A print of this receipt screen picture HG8 becomes a receipt. If there is no printer, the receipt screen picture HG8 itself can be a receipt. The user hands the receipt to a contact person of a convenience store or shows the receipt screen picture HG8 to the contact person when receiving a parcel.

The contact person checks the receipt or the contents displayed on the convenience store terminal 4, and delivers the parcel to the receiver after confirming the parcel and the receiver. Then, the contact person collects a fee from the receiver. It is possible to charge the fee on each receiver when the designation of the reception place is performed instead of paying the fee at the convenience store. In this case, the fee is summed and demanded to each receiver in a predetermined timing, e.g., monthly, or paid by direct debit from a bank account.

Next, a general flowchart of the process in the home-delivery system 1 will be explained.

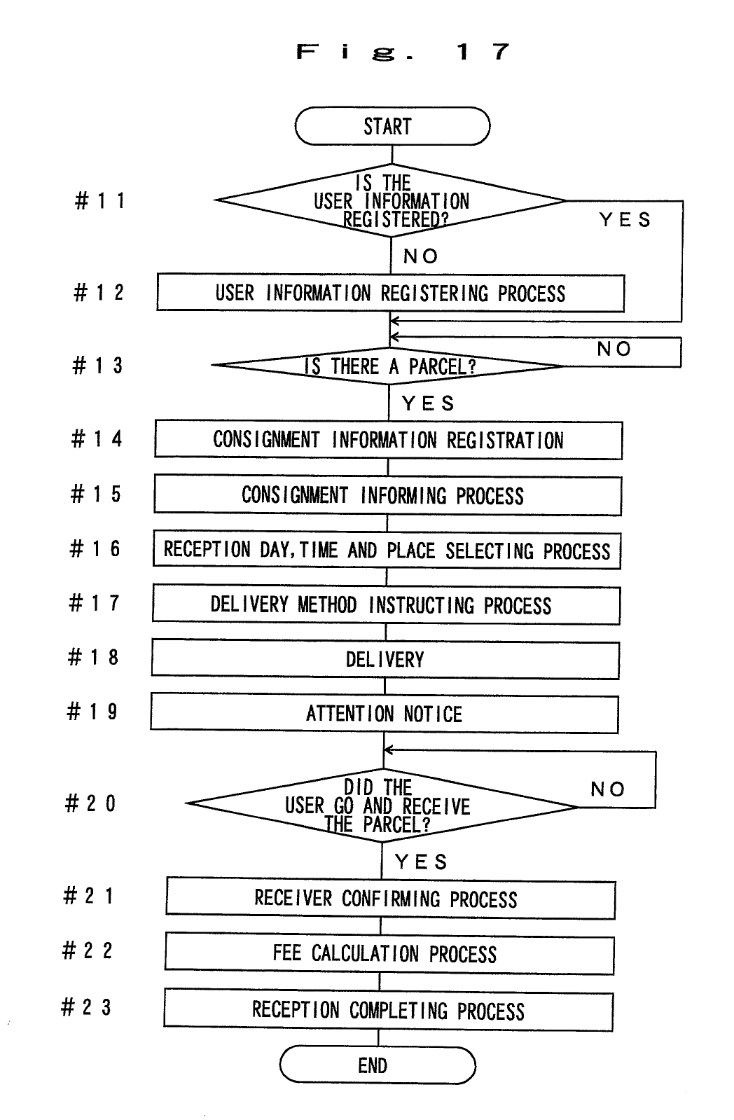

FIG. 17 is a general flowchart of the process in the home-delivery system 1.

In FIG. 17, the user information is registered first (#11, 12). If there is a parcel to be received by a registered user (Yes in #13), the consignment information is registered in the home-delivery server 3 (#14), the user is informed of the parcel information NJ (#15)

The user designates a place, a day and a time for receiving the parcel (#16). When the place, day and time for receiving the parcel are determined, the home-delivery company instructs the delivery method for the parcel (#17). In accordance with this instruction, the parcel is delivered to the designated convenience store (#18). An attention notice is sent to the user for inviting reception of the parcel (#19).

When the user goes to the convenience store for receiving the parcel (Yes in #20), it is confirmed whether the user is the correct receiver (#21). The user receives the parcel and pays a fee (#22). For completion of the deliver of the parcel, the reception date is recorded in the consignment information database DB3 (#23).

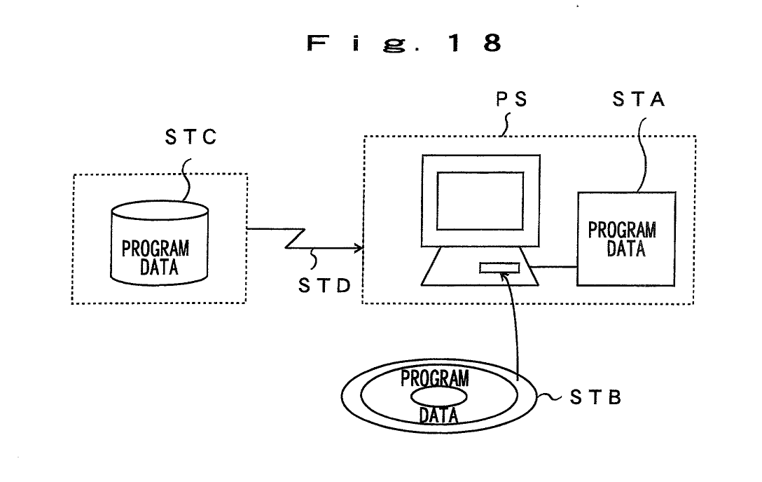

FIG. 18 shows a form of a recording medium ST of a program for executing a method according to the present invention.

As shown in FIG. 18, a memory device STA such as a main memory, a RAM, a ROM, or a hard disk provided in a processor PS, a portable medium STB such as a CD-ROM, a floppy disk, or a magnet-optical disk, a network medium STC such as a server or a DASD connected via a network or a communication line STD, or a communication line STD itself can be used as the recording medium ST.

If the recording medium ST is the portable medium STB, the program is read out by a drive device corresponding to the kind of the portable medium STB, is stored in the memory device STA of the processor PS or loaded on the main memory to be executed. If the recording medium ST is the network medium STC, the program is downloaded to the memory device STA via the communication line STD or transmitted as necessity to be executed. The program can be supplied so as to work on various operating systems, platforms or under system conditions or network environments.

In the above-mentioned embodiments, the home-delivery server 3 can be constituted as a part of the distribution system 9. As the convenience store terminal 4 or the user terminal 5, a personal computer, a workstation, various mobile terminals, a game machine having a communication function or a cellular phone can be used. The database DB provided to the home-delivery server 3 can be integrated as a database or divided into plural databases. The structure and contents of the database DB can be modified variously. A partial or whole structure of the home-delivery system 1, the structure, the contents, the layout of the screen HG as well as characters of display, the contents and the order of the process can be modified if necessary in accordance with the scope of the present invention.

The consignment relay station in the present invention is not limited to a convenience store shown as an example in the embodiment, but can be a place that can store a parcel to be distributed temporarilly, such as a distribution lodgment or a sales office of a distribution company. In addition, it is desirable that the opening hours of the consignment relay station is long so that a receiver can go there for receiving a parcel at any time.

According to the present invention, a home-delivery company can improve the efficiency of delivering parcels, while a receiver can receive a parcel at a convenient day and time in a convenient place.

While the presently preferred embodiments of the present invention have been shown and described, it will be understood that the present invention is not limited thereto, and that various changes and modifications may be made by those skilled in the art without departing from the scope of the invention as set forth in the appended claims.

What is claimed is:

1. A home-delivery method for a receiver to receive a parcel, comprising the steps of:
registering consignment information of the parcel to be received by the receiver in a home-delivery server;
transmitting parcel information from the home-delivery server to a receiver's terminal after the consignment information is registered in the home-delivery server and before the parcel is delivered;
receiving information by the home-delivery server, the information being about a day, a time and a consignment relay station that the receiver designates for receiving the parcel; and
delivering a collected parcel to the consignment relay station that is designated by the receiver.

2. The home-delivery method according to claim 1, wherein the parcel information includes information about contents, weight and dimensions of the parcel, and the receiver designates the consignment relay station by selecting a place for receiving a parcel from a group including at least the receiver's home and working place.

3. The home-delivery method according to claim 1, wherein the registering step includes the steps of transmitting a map of the area selected by the receiver to the receiver's terminal from the home-delivery server, and selecting a consignment relay station displayed on the receiver's terminal by the receiver.

4. The home-delivery method according to claim 3, wherein information about a privilege is displayed, the privilege being given to the receiver when the receiver receives the parcel at the designated day and time in the displayed consignment relay station.

5. A home-delivery server used in a home-delivery system for a receiver to receive a parcel, comprising:
a database for registering consignment information about the parcel to be transmitted to the receiver;
means for transmitting parcel information to a receiver's terminal after the consignment information is registered in the home-delivery server and before the parcel is delivered;
means for receiving information about a day, a time and a consignment relay station that the receiver designates for receiving the parcel; and
means for instructing the consignment relay station designated by the receiver to deliver the parcel.

6. The home-delivery server according to claim 5, further comprising means for transmitting a map including a consignment relay station in the area selected by the receiver for the receiver to designate a consignment relay station.

7. The home-delivery server according to claim 5 or claim 6, further comprising means for informing the receiver of a message at a timing before the day and time designated by the receiver, the message being for inviting the receiver to receive the parcel.

8. A computer-readable recording medium storing a program executed by a computer in a home-delivery system for a receiver to receive a parcel, the program comprising the steps of:
registering consignment information in a database of a home-delivery server;
transmitting parcel information to a receiver's terminal after the consignment information is registered in the database and before the parcel is delivered;
receiving information about a day, a time and a consignment relay station that the receiver designates for receiving the parcel; and
instructing the consignment relay station designated by the receiver to deliver the parcel.
